(19) United States
(12) Patent Application Publication
(10) Pub. No.: US 2022/0343118 A1
(43) Pub. Date: Oct. 27, 2022

(54) ELECTRONIC DEVICE PERFORMING IMITATION LEARNING FOR BEHAVIOR AND OPERATION METHOD THEREOF

(71) Applicant: ELECTRONICS AND TELECOMMUNICATIONS RESEARCH INSTITUTE, Daejeon (KR)

(72) Inventor: Jin Chul CHOI, Daejeon (KR)

(21) Appl. No.: 17/551,929

(22) Filed: Dec. 15, 2021

(30) Foreign Application Priority Data
Apr. 21, 2021 (KR) 10-2021-0051653

(51) Int. Cl. G06K 9/62

(52) U.S. Cl. CPC G06K 9/6263; G06K 9/6228; G06K 9/6256

(57) ABSTRACT

Disclosed is a method of operating an electronic device for learning a behavior of a user, which includes receiving input data related to the behavior of the user, obtaining first behavior trajectory information by processing the input data, generating an initial behavior policy based on the first behavior trajectory information, obtaining second behavior trajectory information based on the initial behavior policy, sampling the first behavior trajectory information and the second behavior trajectory information, training an evaluation model for classifying the first behavior trajectory information and the second behavior trajectory information, and updating the initial behavior policy based on the evaluation model.

### CROSS-REFERENCE TO RELATED APPLICATIONS

This application claims priority under 35 U.S.C. § 119 to Korean Patent Application No. 10-2021-0051653, filed on Apr. 21, 2021, in the Korean Intellectual Property Office, the disclosures of which are incorporated by reference herein in their entireties.

### BACKGROUND

Embodiments of the present disclosure described herein relate to an imitation learning technique, and more particularly, relate to an electronic device for performing imitation learning for a behavior by deriving a policy for determining a behavior similar to that of an expert, and an operating method thereof.

In the early days, robots are limited to the role of performing repetitive tasks instead of humans for the purpose of automating and unmanning tasks at the production site. However, in recent years, the field of activity of robots has expanded, service robots such as guide robots and educational robots that require complex interaction with humans are being developed, and due to the diversification of products, factory robots are also required to be scalable for new tasks.

In addition, intelligent things that will replace or assist human tasks, such as home service robots, autonomous vehicles, drones, and the Internet of things, are being considered, and research and development associated with them are being actively conducted.

In this environment, imitation learning is being studied as a method to ensure the scalability of intelligent things. This means that when intelligent things are required to perform new tasks in a new environment, they are performed by imitating human behavior. As a learning-based method, imitation learning may ensure scalability to broaden the range of behaviors that can be performed. In addition, a generalized method for various tasks may be proposed by considering the demonstration of a person who has already reflected them, rather than considering the different goals and conditions for each task.

### SUMMARY

Embodiments of the present disclosure provide an electronic device for behavior imitation learning that derives a policy for determining a behavior similar to that of an expert based on the expert's demonstration data, and an operating method thereof.

According to an embodiment of the present disclosure, a method of operating an electronic device for learning a behavior of a user includes receiving input data related to the behavior of the user, obtaining first behavior trajectory information by processing the input data, generating an initial behavior policy based on the first behavior trajectory information, obtaining second behavior trajectory information based on the initial behavior policy, sampling the first behavior trajectory information and the second behavior trajectory information, training an evaluation model for classifying the first behavior trajectory information and the second behavior trajectory information, and updating the initial behavior policy based on the evaluation model.

According to an embodiment, the input data may include state data associated with a current state of the electronic device and control data input by the user to control the electronic device.

According to an embodiment, the obtaining of the first behavior trajectory information may further include generating the first behavior trajectory information composed of a pair of the state data and the control data by matching the state data and the control data.

According to an embodiment, the generating of the initial behavior policy may further include deriving the initial behavior policy through supervised learning for the first behavior trajectory information.

According to an embodiment, the obtaining of the second behavior trajectory information may further include obtaining state data associated with a current state of the electronic device from the input data, deriving autonomous control data for controlling the electronic device by processing the state data based on the initial behavior policy, and generating the second behavior trajectory information composed of a pair of the state data and the autonomous control data by matching the state data and the autonomous control data.

According to an embodiment, the sampling may further include generating a first data set by tracking the first behavior trajectory information, generating first sample data by sampling the first data set with a specified batch size, generating a second data set by tracking the second behavior trajectory information, and generating second sample data by sampling the second data set with the specified batch size.

According to an embodiment, the training of the evaluation model may further include adding a label for distinguishing a source of a behavior policy and whether a task is successful with respect to the first sample data and the second sample data, and training the evaluation model to distinguish the first sample data and the second sample data based on the label using supervised learning.

According to an embodiment, the updating of the initial behavior policy may further include performing learning on the initial behavior policy through reinforcement learning using the evaluation model as a reward function.

According to an embodiment, the updating of the initial behavior policy may further include obtaining third behavior trajectory information based on the trained behavior policy, and generating third sample data by sampling the third behavior trajectory information.

According to an embodiment, the method may further include training the evaluation model based on the first sample data and the third sample data and updating the trained behavior policy.

According to an embodiment of the present disclosure, an electronic device includes a sensor that obtains state data associated with a current state of the electronic device, a driving device that is driven based on control data input by a user, and a processor that trains a behavior of the user. The processor includes a data processing circuit that receives the state data and the control data and obtains first behavior trajectory information by matching the state data and the control data, and a behavior policy learning circuit that generates an initial behavior policy based on the first behavior trajectory information, obtains second behavior trajectory information based on the initial behavior policy, trains an evaluation model for classifying the first behavior trajectory information and the second behavior trajectory information, and updates the initial behavior policy based on the evaluation model.

According to an embodiment, the first behavior trajectory information may include information on a behavior feature vector composed of a pair of the state data and the control data.

According to an embodiment, the behavior policy learning circuit may derive the initial behavior policy through supervised learning for the first behavior trajectory information.

According to an embodiment, the behavior policy learning circuit may derive autonomous control data for controlling the electronic device by processing the state data based on the initial behavior policy, and may generate the second behavior trajectory information composed of a pair of the state data and the autonomous control data by matching the state data and the autonomous control data.

According to an embodiment, the behavior policy learning circuit may generate first sample data by sampling the first behavior trajectory information, may generate second sample data by sampling the second behavior trajectory information, and may add a label for distinguishing a source of a behavior policy and whether a task is successful with respect to the first sample data and the second sample data.

According to an embodiment, the behavior policy learning circuit may train the evaluation model to distinguish the first sample data and the second sample data based on the label using supervised learning.

According to an embodiment, the behavior policy learning circuit may perform learning on the initial behavior policy through reinforcement learning using the evaluation model as a reward function.

According to an embodiment, the behavior policy learning circuit may evaluate the trained behavior policy and may store a final behavior policy when a performance of the trained behavior policy meets a criteria.

### BRIEF DESCRIPTION OF THE FIGURES

The above and other objects and features of the present disclosure will become apparent by describing in detail embodiments thereof with reference to the accompanying drawings.

FIG. 1 is a diagram illustrating an environment in which an electronic device according to an embodiment of the present disclosure is utilized.

FIG. 2 is a block diagram of the electronic device according to an embodiment of the present disclosure.

FIG. 3 is a block diagram of a behavior policy learning circuit of the electronic device of FIG. 2.

FIG. 4 is a flowchart illustrating a method of operating an electronic device according to an embodiment of the present disclosure.

FIG. 5 is a flowchart illustrating operation S150 of FIG. 4 in detail.

### DETAILED DESCRIPTION

Hereinafter, embodiments of the present disclosure will be described clearly and in detail such that those skilled in the art may easily carry out the present disclosure.

Hereinafter, the best embodiment of the present disclosure will be described in detail with reference to accompanying drawings. With regard to the description of the present disclosure, to make the overall understanding easy, similar components will be marked by similar reference signs/numerals in drawings, and thus, additional description will be omitted to avoid redundancy.

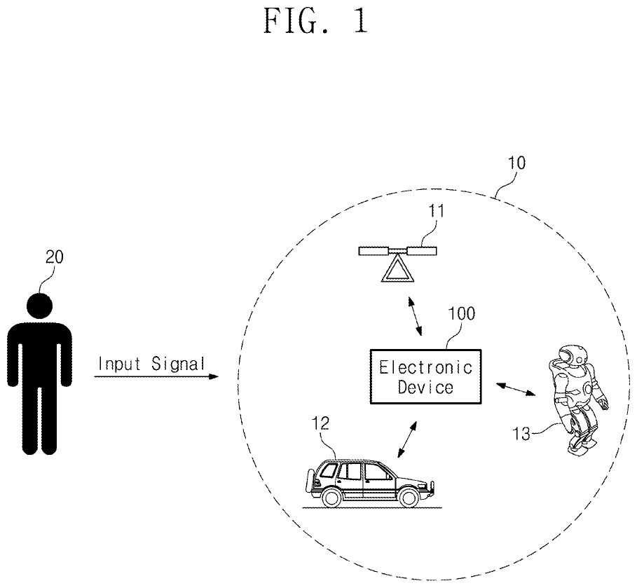

FIG. 1 is a diagram illustrating an environment in which an electronic device according to an embodiment of the present disclosure is utilized. Referring to FIG. 1, a thing 10 may include an intelligent thing or an autonomous thing that receives an input signal from a user 20 and trains by imitation of a behavior of the user 20 based on the input signal. For example, the thing 10 may include a drone 11, a vehicle 12, and a robot 13.

Abilities to learn through experience and trial and error is an important element of intelligence. These abilities may be embodied in the form of reinforcement learning. The reinforcement learning is a learning method that selects the optimal behavior according to a given state, and aims to establish a policy that may receive the maximum reward in a specific state by considering the good or bad degree of the behavior determined in the specific state. However, in many real-world problems, it is difficult to accurately measure and model the reward according to the behavior, so there is a limitation in its usefulness.

As an alternative to this, imitation learning that determines a behavior in a specific state like an expert based on a demonstration or behavior history data of the expert is in the spotlight. The goal of imitation learning is to train and derive policies similar to the behavioral policies of experts. Behavior cloning, a class of imitation learning, uses regression analysis or supervised learning to derive a policy in which demonstration data and learner's behavior are directly mapped according to each state of an expert. Although this method is simple, it does not consider the problem of overfitting the demonstration data and the correlation between continuous behaviors, so there is a problem that the error increases as time goes by.

The thing 10 according to the present disclosure is a type of imitation learning, and may derive policy for determining a behavior similar to an expert based on a generative adversarial learning technique. The generative adversarial learning technique refers to a technique in which a behavior policy creator and a behavior policy discriminator repeatedly confront each other and derive an improved behavior policy.

The thing 10 may include an electronic device 100 to perform the generative adversarial learning technique. The electronic device 100 may perform learning on the behavior of the user 20 and may imitate the behavior of the user 20 based on the generative adversarial learning technique. The user 20 may be an expert, and the electronic device 100 may generate behavioral intelligence to act by itself without specific instructions or manipulations from the user 20 by imitating the behavior of the expert.

According to an embodiment, the electronic device 100 may be implemented in an external server. In this case, the electronic device 100 may allow the drone 11, the vehicle 12, or the robot 13 to train and imitate the behavior of the user 20 while exchanging data and signals with at least one of the drone 11, the vehicle 12, and the robot 13.

According to an embodiment, the electronic device 100 may be implemented in at least one of the drone 11, the vehicle 12, and the robot 13. In this case, the electronic device 100 may train and imitate the behavior of the user 20 by directly receiving an input signal or input data from the user 20. For convenience of description, in the following specification, it is assumed that the electronic device 100 is implemented in at least one of the drone 11, the vehicle 12, and the robot 13.

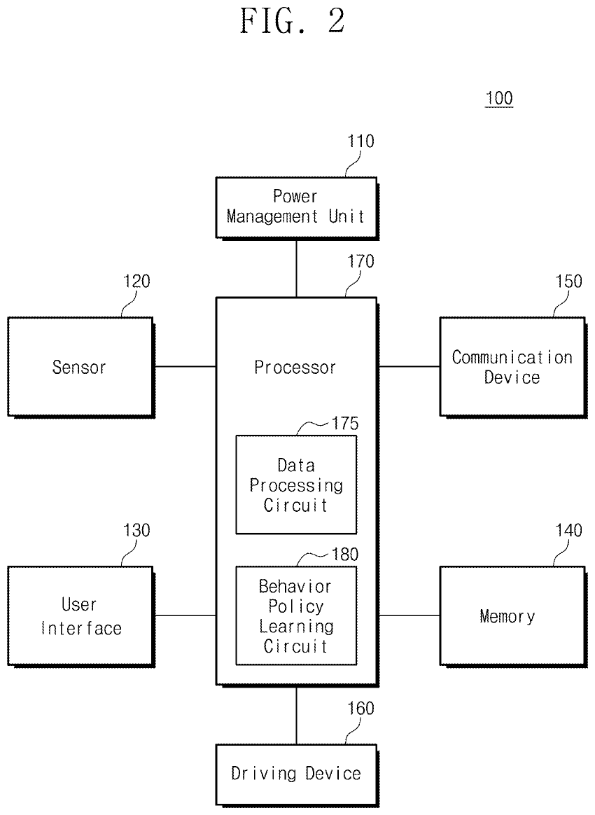

FIG. 2 is a block diagram of the electronic device according to an embodiment of the present disclosure. Referring to FIGS. 1 and 2, the electronic device 100 may include a power management unit 110, a sensor 120, a user interface 130, a memory 140, a communication device 150, a driving device 160, and a processor 170.

The power management unit 110 may supply power to the electronic device 100. The power management unit 110 may receive power from a battery and supply power to each unit of the electronic device 100. For example, the power management unit 110 may be implemented with a switched-mode power supply (SMPS).

The sensor 120 may sense state data of the electronic device 100. The state data may include data on a current state of the electronic device 100. For example, the sensor 120 may include at least one of a speed sensor, an acceleration sensor, a coordinate sensor, a tilt sensor, a forward/reverse sensor, a battery sensor, a fuel sensor, a steering sensor, a temperature sensor, a humidity sensor, an ultrasonic sensor, an illumination sensor, and an acceleration and brake sensor.

The sensor 120 may generate the state data of the electronic device 100 based on a signal generated by at least one sensor. For example, the state data may include velocity data, acceleration data, spatial coordinate data, and other sensing data.

According to an embodiment, the sensor 120 may include at least one sensor capable of detecting an object external to the electronic device 100. For example, the sensor 120 may include at least one of a camera, a radar, a lidar, an ultrasonic sensor, and an infrared sensor. The sensor 120 may generate information associated with an external object based on a signal generated by at least one sensor.

The user interface 130 may receive an input signal from the user 20 and provide the user 20 with information generated by the electronic device 100. The user interface 130 may include an input device and an output device. For example, the input device may include a touch input device, a mechanical input device, a voice input device, a gesture input device, etc. For example, the output device may include a speaker, a display, a haptic module, etc.

The memory 140 may be electrically connected with the processor 170. The memory 140 may store basic data for a unit, control data for operation control of the unit, and input/output data. The memory 140 may store data processed by the processor 170. The memory 140 may be configured as at least one of a ROM, a RAM, an EPROM, a flash drive, and a hard drive in terms of hardware. According to an embodiment, the memory 140 may be implemented integrally with the processor 170 or may be classified as a sub-configuration of the processor 170.

The communication device 150 may exchange signals with a device located outside the electronic device 100. The communication device 150 may include at least one of a transmit antenna, a receive antenna, a radio frequency (RF) circuit capable of implementing various communication protocols, and an RF component to perform communication.

The driving device 160 may be a device that electrically controls the physical driving of the electronic device 100. For example, the driving device 160 may control a steering, a speed, an acceleration, a brake, a tilt, and a ramp of the electronic device 100, and operations of an engine, rising/falling of the drone, an RPM of a propeller, limbs of the robot, etc.

The processor 170 is electrically connected to the power management unit 110, the sensor 120, the user interface 130, the memory 140, the communication device 150, and the driving device 160 to exchange signals. The processor 170 may be implemented using at least one of ASICs (application specific integrated circuits), DSPs (digital signal processors), DSPDs (digital signal processing devices), PLDs (programmable logic devices), FPGAs (field programmable gate arrays), processors, controllers, micro-controllers, microprocessors, and an electrical unit for performing other functions. The processor 170 may control at least one of the power management unit 110, the sensor 120, the user interface 130, the memory 140, the communication device 150, and the driving device 160, and thus may drive the electronic device 100.

The processor 170 may include a data processing circuit 175 and a behavior policy learning circuit 180 to train the behavior of the user 20. The data processing circuit 175 may perform data preprocessing associated with imitation learning. The data processing circuit 175 may receive input data related to the behavior of the user 20 through the input signal, and may process the input data to obtain behavior trajectory information of the expert.

The input data may include the state data and the control data. The state data may be obtained by the sensor 120. The control data may be data included in the input signal for the user 20 to control the electronic device 100. For example, the control data may include steering control data, acceleration control data, tilt control data, etc., included in a signal for controlling the driving device 160. According to an embodiment, the control data may be expressed as a control value.

According to an embodiment, the control data may include control data generated by the processor 170 based on an input signal of the user 20. For example, the processor 170 may generate a control signal for controlling at least one of the power management unit 110, the user interface 130, the memory 140, the communication device 150, and the driving device 160 based on the input signal, and the control data may be included in the control signal.

The data processing circuit 175 may match the state data and the control data. The data processing circuit 175 may generate a behavioral feature vector implemented as a pair of the state data and the control data by matching the control data of the user 20 according to the state data. The behavior trajectory information may include information on a series of behavioral feature vectors.

The data processing circuit 175 may provide the behavior trajectory information to the behavior policy learning circuit 180. The behavior trajectory information obtained by the data processing circuit 175 may be referred to as first behavior trajectory information as behavior trajectory information of an expert. The first behavior trajectory information may be a basis for behavior policy learning. According to an embodiment, the data processing circuit 175 may be classified as a sub-configuration of the behavior policy learning circuit 180.

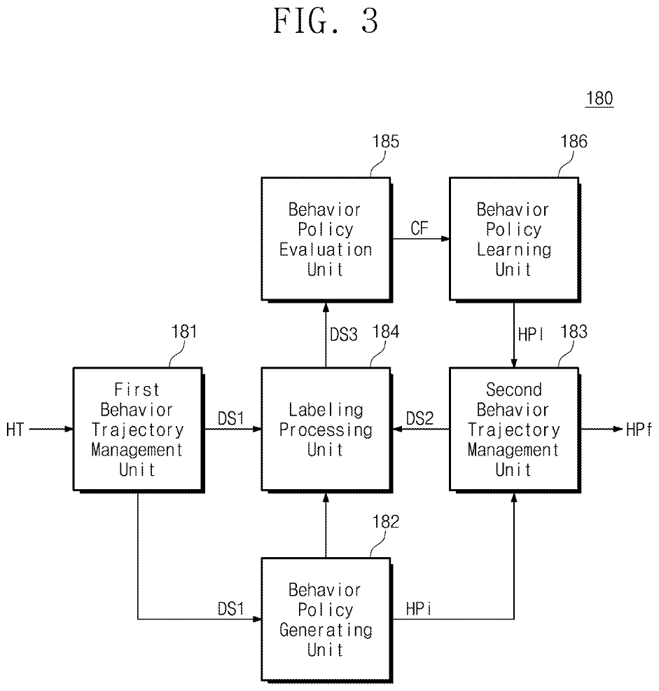

The behavior policy learning circuit 180 may generate an initial behavior policy based on the first behavior trajectory information. The behavior policy learning circuit 180 may obtain behavior trajectory information of a learner based on the initial behavior policy. The learner's behavior trajectory information obtained by the behavior policy learning circuit 180 may be referred to as second behavior trajectory information. The behavior policy learning circuit 180 may train an evaluation model for classifying the first behavior trajectory information and the second behavior trajectory information, and may derive an improved behavior policy based on the evaluation model. In this case, the evaluation model may be used to train the behavioral policy as a reward function. A detailed configuration and operation of the behavior policy learning circuit 180 will be described later with reference to FIG. 3.

As described above, the electronic device 100 may train an evaluation model that distinguishes the first behavior trajectory of the expert and the second behavior trajectory generated through the behavior policy of the learner, and may use the evaluation model as the reward function to train the learner's behavior policy. The electronic device 100 may derive an improved behavior policy similar to that of an expert by repeating a series of processes of training the evaluation model and the behavior policy.

FIG. 3 is a block diagram of a behavior policy learning circuit of the electronic device of FIG. 2. Referring to FIGS. 2 and 3, the behavior policy learning circuit 180 may include a first behavior trajectory management unit 181, a behavior policy generating unit 182, a second behavior trajectory management unit 183, a labeling processing unit 184, a behavior policy evaluation unit 185, and a behavior policy learning unit 186.

The first behavior trajectory management unit 181 may receive first behavior trajectory information HT from the data processing circuit 175. According to an embodiment, the first behavior trajectory management unit 181 may directly generate the first behavior trajectory information HT. The first behavior trajectory management unit 181 may generate a first data set by tracking the first behavior trajectory information HT.

The first behavior trajectory information HT may include information on the behavior feature vector composed of a pair of the state data and the control data, and the state data and control data may change over time. The first behavior trajectory management unit 181 may generate the first data set associated with the first behavior trajectory information HT by tracking the state data and the control data depending on the state data.

The first behavior trajectory management unit 181 may sample the first data set with a specified batch size. For example, the first data set may be a series of data on joint angles when a robot moves an arm, and the specified batch size may be a normalized size for the sample data, such as a 10×10 size as a matrix size or 1 MHz as a sample rate.

The first behavior trajectory management unit 181 may generate first sample data DS1 by sampling the first data set. The first sample data DS1 may be provided to the behavior policy generating unit 182 and the labeling processing unit 184.

The behavior policy generating unit 182 may generate an initial behavior policy HPi based on the first sample data DS1. The behavior policy may be a function or strategy for outputting control data to be taken by the electronic device 100 when the state data are input. That is, the initial behavior policy HPi may be a behavior function or behavior strategy of the electronic device 100 initially derived through the demonstration data of the user 20.

The behavior policy generating unit 182 may derive the initial behavior policy HPi by performing supervised learning with respect to the first sample data DS1. For example, regression analysis may be used for the supervised learning. The behavior policy generating unit 182 may provide the initial behavior policy HPi to the second behavior trajectory management unit 183.

The second behavior trajectory management unit 183 may obtain the second behavior trajectory information based on the initial behavior policy HPi. The second behavior trajectory management unit 183 may obtain autonomous control data for the state data through the initial behavior policy HPi. The autonomous control data may be data for the electronic device 100 to autonomously control the electronic device 100 without intervention of the user 20 based on the state data.

The second behavior trajectory information may be composed of a pair of the state data and the autonomous control data. The state data and the autonomous control data may change over time. The second behavior trajectory management unit 183 may generate a second data set for the second behavior trajectory information by tracking the state data and the autonomous control data according to the state data.

The second behavior trajectory management unit 183 may sample and normalize the second data set with a specified batch size. The second behavior trajectory management unit 183 may generate normalized second sample data DS2. The second sample data DS2 may be provided to the labeling processor 184.

The second behavior trajectory management unit 183 may obtain the second behavior trajectory information based on the initial behavior policy HPi provided from the behavior policy generating unit 182, and then may update the second behavior trajectory information based on the trained behavior policy HPI provided by the behavior policy learning unit 186. The second behavior trajectory management unit 183 may repeat the operation of sampling based on the updated second behavior trajectory information and providing the sampled result to the labeling processing unit 184.

The second behavior trajectory management unit 183 may determine whether the performance of the trained behavior policy HPI satisfies a criteria. For example, the second behavior trajectory management unit 183 may output the final behavior policy Hpf when the value of the loss function for the target function is less than or equal to a predetermined value based on the trained behavior policy HPI or when the performance greater than or equal to the reference value is output as test result based on the trained behavior policy HPl. The final behavior policy HPf may be stored in the memory 140 and may be used in an imitation operation or an inference operation of the electronic device 100.

The labeling processing unit 184 may add a label for distinguishing the first sample data DS1 and the second sample data DS2. For example, the label may include a label that distinguishes whether each sample data are derived from which behavioral policy and whether the task is successful.

Whether each sample data are derived from which behavioral policy may include at least one of whether each sample data are sample data directly derived from the first behavior trajectory information, are sample data derived from the initial behavior policy HPi, and are sample data derived from the trained behavior policy HPl. The success or failure of the task for each sample data may include whether a target task succeeds or fails.

The labeling processing unit 184 may provide the first sample data DS1 and the second sample data DS2 to which the label is added to the behavior policy evaluation unit 185. After the behavior policy is trained, the labeling processing unit 184 may add a label for distinguishing the sample data sampled from the first sample data DS1 and the updated second behavior trajectory information.

The behavior policy evaluation unit 185 may train an evaluation model. The evaluation model may evaluate the first sample data DS1 and the second sample data DS2 based on the label. In this case, the evaluation may be to classify whether the sample data or behavioral trajectory information is derived by which policy and whether the task is successful based on the label.

According to an embodiment, the evaluation model may be defined as a neural network model that takes each labeled sample data as an input and outputs a value having a probability distribution such as whether it is based on the behavioral policy of the expert or the learner, and whether the task is successful, etc. The behavior policy evaluation unit 185 may provide the trained evaluation model to the behavior policy learning unit 186 as a reward function CF.

The behavior policy learning unit 186 may train a behavior policy based on reinforcement learning by using the evaluation model as the reward function CF. The reward function CF may be a feedback function that measures the similarity between the behavior policy being trained and the behavior of the expert. For example, the similarity of the behavior policy may indicate a difference between the control data and autonomous control data according to the same state data.

The behavior policy learning unit 186 may set a target function to minimize a cost function value or a loss function value while maximizing the task success rate, and may train a behavior policy optimizing it. According to an embodiment, a policy gradient-based reinforcement learning technique may be used for learning.

The behavior policy learning unit 186 may provide the trained behavior policy HPl to the second behavior trajectory management unit 183. The trained behavior policy HPl may be used to update the second behavior trajectory information by the second behavior trajectory management unit 183. Thereafter, the second behavior trajectory management unit 183, the labeling processing unit 184, the behavior policy evaluation unit 185, and the behavior policy learning unit 186 may repeat a series of the learning cycle including sampling, labeling, evaluation model learning, and behavior policy learning, thereby improving the performance of the behavior policy. That is, the electronic device 100 may imitate a behavior similar to the behavior of the user 20 without the intervention of the user 20, based on the improved behavior policy.

As described above, the electronic device 100 may generate and train a behavior policy through an arbitrary artificial intelligence model (a behavior policy generator), and may generate behavior trajectory information through the behavior policy. Also, the electronic device 100 may evaluate the behavior policy or behavior trajectory information generated through the evaluation model (a behavior policy discriminator). That is, the electronic device 100 may derive an improved behavior policy by repeating generation and evaluation of the behavior policy or behavior trajectory information through repeated operations of the behavior policy generator and the behavior policy discriminator. Accordingly, the electronic device 100 may implement the generative adversarial learning technique.

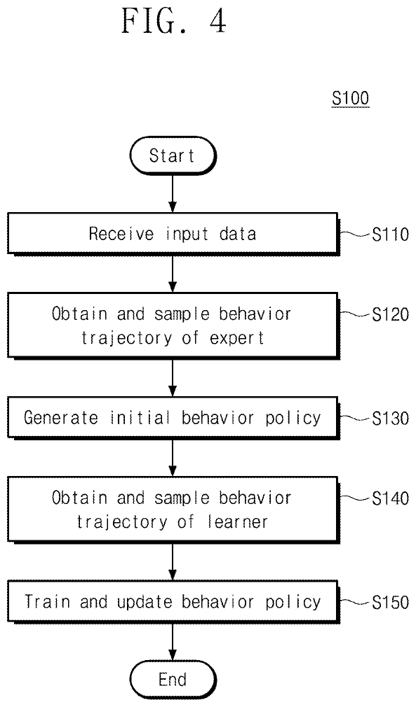

FIG. 4 is a flowchart illustrating a method of operating an electronic device according to an embodiment of the present disclosure. Referring to FIGS. 2 and 4, the electronic device 100 may derive a behavior policy based on input data. The input data may be expressed as the expert's demonstration data, and the behavior policy refers to a function or strategy for performing a behavior similar to that of the expert without the intervention of the expert.

In operation S110, the electronic device 100 may receive input data related to a user's behavior. The input data may include state data on the current state of the electronic device 100 and control data input by the user to control the electronic device 100. The state data may be obtained through the sensor 120, and the control data may be obtained from at least one of the power management unit 110, the user interface 130, the memory 140, the communication device 150, and the driving device 160.

In operation S120, the electronic device 100 may obtain first behavior trajectory information by processing the input data. Processing the input data may include an operation that matches the control data based on the state data. The electronic device 100 may process input data to generate first behavior trajectory information including a pair of the state data and the control data. The first behavior trajectory information may be expressed as behavior trajectory information of the expert derived from an expert's behavior policy.

In addition, in operation S120, the electronic device 100 may sample the generated first behavior trajectory information. The first behavior trajectory information changes over time, and the electronic device 100 may generate a first data set by tracking the first behavior trajectory information. The electronic device 100 may generate normalized first sample data by sampling the first data set with a specified batch size.

In operation S130, the electronic device 100 may generate an initial behavior policy based on the first behavior trajectory information. The initial behavioral policy refers to the behavior policy initially derived based on the expert's demonstration data. In this case, an artificial intelligence model may be used. According to an embodiment, the electronic device 100 may derive an initial behavior policy through supervised learning on the first behavior trajectory information.

In operation S140, the electronic device 100 may obtain the second behavior trajectory information based on the initial behavior policy. The electronic device 100 may derive autonomous control data through the initial behavior policy by inputting the state data. The autonomous control data may be data for the electronic device 100 to autonomously control units in the electronic device 100 without a user's input signal. The electronic device 100 may match the autonomous control data based on the state data to generate the second behavior trajectory information composed of a pair of the state data and the autonomous control data.

In addition, in operation S140, the electronic device 100 may sample the generated second behavior trajectory information. The second behavior trajectory information changes over time, similar to the first behavior trajectory information, and the electronic device 100 may generate a second data set by tracking the second behavior trajectory information. The electronic device 100 may generate normalized second sample data by sampling the second data set with a specified batch size.

In operation S150, the electronic device 100 may train and update the behavior policy. According to an embodiment, a generative adversarial learning technique may be used to train the behavior policy. In detail, the electronic device 100 may generate a behavior policy or behavior trajectory information through an arbitrary artificial intelligence model, and may evaluate the generated behavior policy or the generated behavior trajectory information through the evaluation model. In addition, the electronic device 100 may train a behavior policy by using the evaluation model as a reward function, and may repeatedly perform generation and evaluation operations.

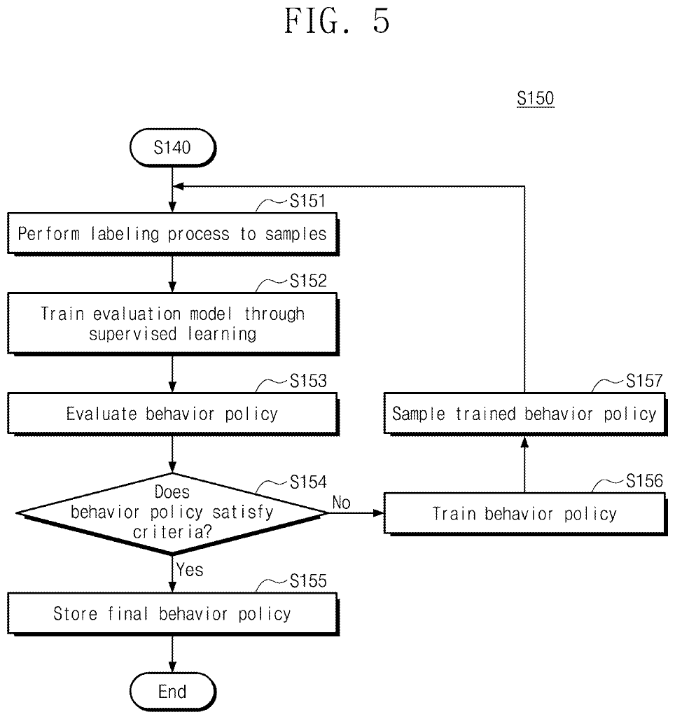

Operation S150 may be implemented through, for example, the second behavior trajectory management unit 183, the labeling processing unit 184, the behavior policy evaluation unit 185, and the behavior policy learning unit 186 of FIG. 3. According to an embodiment, operation S150 may be implemented by a separate neural processor other than the processor 170. Hereinafter, a detailed description of operation S150 will be described later with reference to FIG. 5.

FIG. 5 is a flowchart illustrating operation S150 of FIG. 4 in detail. Referring to FIGS. 2, 4, and 5, the electronic device 100 may train an evaluation model for discriminating the first behavior trajectory information and the second behavior trajectory information, and may update the behavior policy based on the evaluation model.

In operation S151, the electronic device 100 may perform a labeling process with respect to each sample data. The electronic device 100 may add a label for distinguishing a source of a behavior policy and whether a task is successful with respect to the first sample data and the second sample data. The source of the behavior policy may include an expert corresponding to the first behavior trajectory information or a learner corresponding to the second behavior trajectory information. Whether the task is successful may include success or failure of the task performed based on the first behavior trajectory information or the second behavior trajectory information.

In operation S152, the electronic device 100 may train the evaluation model using supervised learning. The evaluation model may be an artificial intelligence model that outputs a value having a probability distribution, such as whether a behavior policy is taken according to an expert/learner, and whether a task succeeds/fails, based on the first sample data and the second sample data to which the label is added.

In operation S153, the electronic device 100 may evaluate the behavior policy through the trained evaluation model. For example, the electronic device 100 may evaluate the similarity between the expert behavior policy and the learner behavior policy. The similarity may indicate a difference between the control data and the autonomous control data with respect to the same state data, and as the similarity increases, the difference may decrease.

In operation S154, the electronic device 100 may determine whether the performance of the behavior policy satisfies a criteria. For example, the electronic device 100 may determine whether the loss function value for the target function is equal to or less than a predetermined value based on the behavior policy, or whether performance equal to or greater than the test result reference value is output based on the behavior policy. When the performance of the behavior policy does not meet the criteria, operation S156 may proceed.

In operation S156, the electronic device 100 may train a behavior policy. The electronic device 100 may perform reinforcement learning by using the evaluation model trained in operation S152 as a reward function. For example, the electronic device 100 may set a target function such that a cost function value or a loss function value is minimized while maximizing a task success rate, and may train a behavior policy to optimize it.

In operation S157, the electronic device 100 may obtain third behavior trajectory information based on the trained behavior policy. The third behavior trajectory information may be the second behavior trajectory information updated based on the trained behavior policy. The electronic device 100 may generate third sample data by sampling the third behavior trajectory information.

Thereafter, operations S151 to S157 may be repeated. In detail, the electronic device 100 may add a label to the first sample data and the third sample data, may train an evaluation model based on the label, may evaluate the behavior policy, and may re-train the behavior policy when the behavior policy does not meet a criteria. These operations may be repeated until it is determined in operation S154 that the performance of the behavior policy satisfies the criteria.

In operation S154, when the electronic device 100 determines that the performance of the behavior policy satisfies the criteria, the process may proceed to operation S155. In operation S155, the electronic device 100 may store the behavior policy that satisfies the criteria as the final behavior policy. The final behavior policy may be a behavior policy trained through repeated learning operations. The electronic device 100 may store the final behavior policy in the memory 140.

According to an embodiment of the present disclosure, the electronic device may derive an evaluation model that distinguishes an expert behavior trajectory from a learner behavior trajectory, and may train a behavior policy based thereon. In addition, by repeating this series of learning cycles, the performance of the behavior policy may be improved. Accordingly, the electronic device may imitate and train the behavior trajectory of the expert in the autonomous IoT environment to build intelligence that behaves similarly to that of the expert without the user's intervention.

The above description refers to embodiments for implementing the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A method of operating an electronic device for learning a behavior of a user, the method comprising:
receiving input data related to the behavior of the user;
obtaining first behavior trajectory information by processing the input data;
generating an initial behavior policy based on the first behavior trajectory information;
obtaining second behavior trajectory information based on the initial behavior policy;
sampling the first behavior trajectory information and the second behavior trajectory information;
training an evaluation model for classifying the first behavior trajectory information and the second behavior trajectory information; and
updating the initial behavior policy based on the evaluation model.

2. The method of claim 1, wherein the input data includes state data associated with a current state of the electronic device and control data input by the user to control the electronic device.

3. The method of claim 2, wherein the obtaining of the first behavior trajectory information further includes generating the first behavior trajectory information composed of a pair of the state data and the control data by matching the state data and the control data.

4. The method of claim 1, wherein the generating of the initial behavior policy further includes deriving the initial behavior policy through supervised learning for the first behavior trajectory information.

5. The method of claim 1, wherein the obtaining of the second behavior trajectory information further includes:
obtaining state data associated with a current state of the electronic device from the input data;
deriving autonomous control data for controlling the electronic device by processing the state data based on the initial behavior policy; and
generating the second behavior trajectory information composed of a pair of the state data and the autonomous control data by matching the state data and the autonomous control data.

6. The method of claim 1, wherein the sampling further includes:
generating a first data set by tracking the first behavior trajectory information;
generating first sample data by sampling the first data set with a specified batch size;
generating a second data set by tracking the second behavior trajectory information; and
generating second sample data by sampling the second data set with the specified batch size.

7. The method of claim 6, wherein the training of the evaluation model further includes:
adding a label for distinguishing a source of a behavior policy and whether a task is successful with respect to the first sample data and the second sample data; and
training the evaluation model to distinguish the first sample data and the second sample data based on the label using supervised learning.

8. The method of claim 7, wherein the updating of the initial behavior policy further includes performing learning on the initial behavior policy through reinforcement learning using the evaluation model as a reward function.

9. The method of claim 8, wherein the updating of the initial behavior policy further includes:
obtaining third behavior trajectory information based on the trained behavior policy; and
generating third sample data by sampling the third behavior trajectory information.

10. The method of claim 9, further comprising:
training the evaluation model based on the first sample data and the third sample data and updating the trained behavior policy.

11. An electronic device comprising:
a sensor configured to obtain state data associated with a current state of the electronic device;
a driving device configured to be driven based on control data input by a user; and
a processor configured to train a behavior of the user, and
wherein the processor includes:
a data processing circuit configured to receive the state data and the control data, and to obtain first behavior trajectory information by matching the state data and the control data; and
a behavior policy learning circuit configured to generate an initial behavior policy based on the first behavior trajectory information, to obtain second behavior trajectory information based on the initial behavior policy, to train an evaluation model for classifying the first behavior trajectory information and the second behavior trajectory information, and to update the initial behavior policy based on the evaluation model.

12. The electronic device of claim 11, wherein the first behavior trajectory information includes information on a behavior feature vector composed of a pair of the state data and the control data.

13. The electronic device of claim 11, wherein the behavior policy learning circuit is further configured to derive the initial behavior policy through supervised learning for the first behavior trajectory information.

14. The electronic device of claim 11, wherein the behavior policy learning circuit is further configured to:
derive autonomous control data for controlling the electronic device by processing the state data based on the initial behavior policy; and
generate the second behavior trajectory information composed of a pair of the state data and the autonomous control data by matching the state data and the autonomous control data.

15. The electronic device of claim 11, wherein the behavior policy learning circuit is further configured to:
generate first sample data by sampling the first behavior trajectory information;
generate second sample data by sampling the second behavior trajectory information; and
add a label for distinguishing a source of a behavior policy and whether a task is successful with respect to the first sample data and the second sample data.

16. The electronic device of claim 15, wherein the behavior policy learning circuit is further configured to train the evaluation model to distinguish the first sample data and the second sample data based on the label using supervised learning.

17. The electronic device of claim 16, wherein the behavior policy learning circuit is further configured to perform learning on the initial behavior policy through reinforcement learning using the evaluation model as a reward function.

18. The electronic device of claim 17, wherein the behavior policy learning circuit is further configured to evaluate the trained behavior policy and store a final behavior policy when a performance of the trained behavior policy meets a criteria.
